(19) United States
(12) Patent Application Publication
(10) Pub. No.: US 2010/0313900 A1
(43) Pub. Date: Dec. 16, 2010

(54) Smoking Article Warning Device

(76) Inventor: Clifton C. Heath, Atlanta, GA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/861,210

(22) Filed: Aug. 23, 2010

Related U.S. Application Data
(63) Continuation-in-part of application No. 11/308,444, filed on Mar. 25, 2006, now abandoned.

(51) Int. Cl. A24F 13/16; A24F 13/18; G08B 5/40

(52) U.S. Cl. 131/256; 116/214

(57) ABSTRACT

A user engageable device disposed within the tobacco burning path of a smoking article's ember at a pre-selected point. The device may include a visual and/or audible and/or olfactory warning component which alerts the user in response to a proximate ember. This provides one or a combination of a visual, audible, or olfactory alert to the user that the ember has reached a predetermined point. The device is preferably in the form of a sleeve frictionally engageable around the smoking article, but can also may be engaged upon or impregnated into a wrapper of the article's cylinder. Alternatively, the sleeve type device may be disposed within the wrapper. Alternatively the indicator material may also be in the form of selectively placed integrated or stick-on patches.

This application is a Continuation-in-Part of U.S. application Ser. No. 11/308,444 filed Mar. 25, 2006, which is incorporated in it's entirety by reference.

### BACKGROUND OF THE INVENTION

This disclosed device relates in general to devices for warning a smoker of a smoking article (as defined below) that the article's tobacco ember has reached a pre-selected point on the article's tobacco cylinder, e.g. in close proximity to a filter of the article. More particularly, the disclosed device provides the user a slidably engageable warning or measuring component that is user-positionable to a pre-selected point between the distal end of the smoking article which burns and the proximal end which may have a filter and thereby provide a warning to the user before the burning ember combusts the filter or gets too close to the proximal end and burns the user. The warning provides a means to alert the user that they are in danger of starting a fire should they become complacent.

Further, the device provides the user with the ability to designate a predetermined point on the smoking article at which they would like to cease smoking. A user who wishes to discontinue smoking could use this feature to smoke only small parts of a cigarette at a given time allowing him to slowly reduce the amount of nicotine consumed. The user thus avoids unpleasant nicotine withdrawal symptoms while further avoiding the financial cost and unpleasant physical side effects of smoking cessation medications.

Smoking of tobacco and herbs and other plant material has been popular for centuries. Conventionally, a cigarette is formed of compacted tobacco held in a cylindrical shape by a combustible wrapper. Cigars are similarly formed and employ a combustible wrapper of tobacco leaf to hold the compacted inner cylindrical core of tobacco in place.

In use, the smoker lights the distal end of the smoking article and draws or inhales from the proximal end. The proximal end may or may not have a filter component. The user will generally hold the smoking article between two fingers adjacent to the proximal end during use. As the tobacco core burns from the distal end toward the proximal end, a burning ember formed of the tobacco or other material advances toward the proximal end. Smoke drawn through the tobacco core leaves deposits on the remaining tobacco making it stronger when burned. The burning ember if allowed to advance too close to the proximal end of the smoking article, can burn the user's fingers or can ignite the non-tobacco filter material and produce a distasteful and possibly hazardous smoke which can be drawn into the mouth and lungs of a user.

Besides this health risk from smoking the filter, allowing the smoking article to burn too close to the filter or proximal end is an extreme fire danger. Smokers who fall asleep or become distracted are in danger of starting a fire especially if the reason for the smoking article having advanced so far toward the proximal end is that they are asleep or have set the smoking article down and forgotten it. One embodiment of the device herein significantly reduces the danger of fire as it will extinguish the flame on the smoking article. For both fire danger reasons and health reasons, it would be advantageous if the user were warned or alerted to the burning distal end of smoking article advancing too close to the proximal end or filter. Increased utility is provided with a mode of the device which will also extinguish the advancing flame before reaching a predetermined point on the smoking article.

U.S. Pat. No. 5,154,192 by Sprinkel, et al. discloses thermal indicators for non-combustion smoking articles. Such devices feature a sidewall which does not burn and an axial core which is packed with tobacco or other plant matter that is to be smoked. Because the sidewall defining the axial core housing the compacted tobacco does not burn on such devices and the user is unable to see the flame or burning ember, Sprinkel permanently positions visually discernable indicators at positions along the noncombustible sidewall. As the sidewall heats from the flame of combusting tobacco inside the axial core, the permanent indicators chemically react to provide visual indications of temperature changes. However, Sprinkel does not provide any means to provide a visible indicator on a combustible sidewall of a cigar or cigarette since it employs markers deposited on a permanent sidewall. Further, Sprinkel does not allow the user to adjust the position of the visual indicator to various positions between the distal and proximal end but instead simply provides fixed indicators on the noncombustible sidewall.

As such, there is an unmet need for a visual indicator device which is engageable upon a conventional smoking article such as a cigarette or cigar and which may be purchased separately therefrom and employed by users on a plurality of such smoker's articles. Alternatively, the device may be provided at a one to one ratio within the packaging of the smoking article. Such a device should be slidably engageable about the exterior circumference of the smoker's article to any point between the distal or burning end and the proximal end where the filter is located and the user grips the smoking article with their fingers. Still further, such a device should be repositionable to allow smoking in increments and in different sequential sittings. Additionally, in addition to providing the user a warning, visually or otherwise, that the flame has advanced too close to the proximal end, such a device should provide a means to extinguish the smoking article should the burning tobacco approach too close to a determined point such as the filter or a gripping position for the user's fingers.

### SUMMARY OF THE INVENTION

The above noted shortcomings and problems are overcome by the herein disclosed slidably engageable and user positionable warning device which is adapted for engagement to one or a plurality of smoker's articles.

In a particularly preferred embodiment the warning device is configured in the form of a frictionally engaged, slidable or movable ember-reactive sleeve. The sleeve is configured to frictionally engage around the tobacco cylinder formed by a combustible sidewall of a smoking article such as a cigarette or cigar. Once so engaged, the sleeve is translatable in its slidable engagement about the circumference of the smoking article between the burning end and the proximal end which is placed in the user's mouth to draw the smoke therein.

As used herein above and below, the term “smoking article” refers to conventional cigarettes which are formed by a combustible sidewall encircling a tobacco or other plant core and is either filtered or unfiltered, or conventional cigars also having a combustible sidewall conventionally formed of tobacco leaf. Or, the smoking article may be any product having a smokeable cylindrical core of tobacco of any length or girth, either wrapped in a conventional combustible sidewall of paper or otherwise held in a compacted configuration which allows the core of tobacco to burn from the distal end toward the proximal end engageable with the user's mouth.

A particularly advantageous function of this invention is to pre-select an interface point for positioning of the slidable device, along the path of a burning ember from a starting point at a distal end which is lit to burn first and the proximal end which is placed in contact with the smoker's body either in their hand or mouth where the smoking article is drawn upon by the user. As noted, some such smoking articles are unfiltered wherein the danger to the smoker is burning their lips or hand. Also, some smoking articles have a filter and due to the contents of the filter should a communication between the filter and the heat or the flame of the ember occur, it can combust materials in the filter. It is especially unhealthy for a person to inhale smoke from a burning cigarette filter.

However, this burning of the skin of the user and/or exposure to toxic smoke can easily occur when a cigarette smoker does not notice that a cigarette ember is burning in close proximity to the cigarette's filter. Often a smoker only notices that the filter is burning by the acrid taste of the smoke but by then the smoker has already inhaled a significant amount of filter smoke. Also, frequently the ember of a cigarette falls off when it reaches the filter. This creates a dangerous situation because the still burning ember can start a fire if it falls into or onto combustible material.

By slidably engaging the disclosed device to a position adjacent along the path of the ember between the filter and distal end of the cigarette or smoking article, the disclosed device provides a means to intercept and prevent the accidental burning of the user and/or the inhaling of the noxious filter material by the smoker.

Instead, as the burning tobacco or other material forming an ember approaches the filter or proximal end along the path from the distal end, the disclosed device prevents such situations by alerting a smoker that the ember is at or very close to a combusting of the filter or a burning of their hand. Further, the device in a particularly preferred mode, will act as a heat sink and means to extinguish the burning ember when the device and the ember reach contact along the path. A smoker an thus be alerted and can extinguish the cigarette before such occurrences happen or in the mode where the device causes an extinguishment, the device serves to prevent both fire and toxic smoke exposure.

As another advantage, the disclosed device allows a smoker to smoke in the dark, for the purpose of, for example, relaxation or to save electricity or for better viewing of a television. As will be seen, certain embodiments of this invention will provide a warning or indication, that the combusting tobacco or herb or other material, is approaching the proximal end or filter, as described herein, even in the dark. Another preferred mode of the device will act to extinguish the smoking article thereby preventing potential fire.

An additional advantage of the slidable mode of the device herein is to warn and allow a user to extinguish the smoking article prior to the flame or burning material reaching a point between the distal and proximal end where excessively strong smoke may be inhaled. As a cigarette or cigar burns from the distal end toward the proximal end, smoke drawn through the unburned tobacco deposits carcinogens therein in addition to what already exists. Consequently, the longer the burning end advances toward the proximal end, the stronger and more hazardous the remaining tobacco or herb becomes.

If the user extinguishes the cigarette or cigar at a point before the flame advances too close to the filter or proximal end or employs the mode of the device which does so automatically, the user avoids burning and inhaling smoke from the remaining tobacco which has become even more potent and hazardous from the smoke communicated therethrough from the distal end. The slidable mode of the device and user-positioning thereof, provides the user with a means to self adjust when the visual means to ascertain how far the flame has advanced or the point on the smoking article where the device will extinguish the smoking article. In all modes of the device, a visual or olfactory warning is provided that the ember is approaching too closely to the proximal end which is discernable even in dim light or darkness. The smoker so alerted, may allow the self-extinguishing mode to extinguish the smoking article or they may extinguish the smoking article once they discern the warning and before inhaling the stronger smoke from the tobacco adjacent to the filter or proximal end. In the mode of the device adapted to close the aperture from which the distal end of the cigarette extends, the device provides the noted automatic means to extinguish the smoking article once the distal end burns into the axial cavity behind one or a pair of closing members. A metal mode of the device may be adapted to extinguish the burning ember by absorbing sufficient heat that it lowers the temperature of the ember below that where combustion may continue.

As another advantage, a sleeve embodiment of this invention can be slid anywhere along the tobacco cylinder of a smoking article, allowing a smoker to selectively place the sleeve to be notified when a desired fraction (e.g. ½ or ⅓ or ¼) of the article has been consumed, in order to minimize smoking or to save some of the article for later smoking. In this way a smoking article can be smoked in selected increments for health reasons or for other reasons. When the smoker is on a plan to eliminate their habit and is allowed to smoke in ever decreasing but measured amounts, sliding the device to allow discerning of fractional use of the cigarette will help.

In another mode of the disclosed device, the sleeve is adapted for its slidable engagement about the circumference of a smoking article and is formed of metal or ceramic material which will absorb heat. In this mode of the device, the sleeve will absorb sufficient heat from the ember to cause extinguishment and thus will provide a means to extinguish the smoking article before the flame reaches the filter or the fingers of the user at the proximal end. Additionally, as noted above, a biased cap may be provided which is adapted to close upon the distal end of the burning smoking article to extinguish it by deprivation of oxygen.

As will be described in more detail below, examples of preferred indications are as follows: a bright or colorful glowing of the warning sleeve according to this invention, a glowing that is easily distinguishable from the ember; or a sparkling or sizzling of the sleeve; or any combination of these indications.

It should be noted that this invention can be used advantageously on any smoking article whether filtered or unfiltered.

Other advantages and attributes of this invention will be readily discernible upon a reading of the text hereinafter.

### OBJECTS OF THE INVENTION

A particularly preferred object of this invention is the provision of a device which will prevent fires due to smoking articles.

An additional object of the disclosed device is the provision of one or a combination of alerts or warnings including a visual, audible, or olfactory warning to the user which may be communicated in a darkened room.

An object of this invention is to provide a device that visually and/or audibly alerts a smoking article smoker when the article's tobacco ember is at a pre-selected point along the tobacco cylinder of the article.

Another object of this invention is the provision of a device which will alert the user to the ember proximity to the proximal end using an olfactory alert means.

An object of this invention is to provide a device that visually and/or audibly and or by olfactory means, alerts a smoking article smoker when the cigarette ember is in unsafe proximity to the article's filter, before the ember reaches the filter.

A further object of this invention is to provide a sleeve on a smoking article's tobacco cylinder that visually and/or audibly and/or by olfactory means, reacts to the article's tobacco ember, and in response alerts the smoker of said article that the ember is in unsafe proximity to the article's filter.

A further object of this invention is to provide a warning device embodied as a preceding sleeve extending from a filter of a smoking article, the sleeve alerting a smoker of the article when the article's tobacco ember is at or in close proximity to the filter.

Yet another object of the present invention is the provision of a warning device for a smoking article which provides a user means for adjustment of the amount of the smoking article which is allowed to burn.

A still further object of the invention is the provision of such a warning device which also provides means to extginguish the ember or flame on the smoker article.

These objects, and other objects expressed or implied in this document, are accomplished by a device disposed in the tobacco burning path of a smoking article's ember, the device producing an indication in response to encountering the ember for alerting the smoker that the ember has reached the device. The device preferably comprises a material disposed at a pre-selected point in the tobacco burning path of the smoking article, the material producing an indication in response to encountering the ember for alerting the smoker that the ember is at the pre-selected point. The material is preferably in the form of a sleeve that is disposed around the tobacco cylinder of a smoking article.

### BRIEF DESCRIPTION OF THE DRAWINGS

FIG. 1 is a side view of a typical filtered smoking article.

FIG. 2 is a side view of a filtered smoking article incorporating a warning sleeve according to this invention.

FIG. 3 is a side view of a freshly lit filtered smoking article incorporating a warning sleeve according to this invention.

FIG. 4 is a side view of a filtered smoking article incorporating a warning sleeve according to this invention, with the ember approaching the filter.

FIG. 5 is a side view of a filtered smoking article incorporating a warning sleeve according to this invention, from which the ember has broken off after reaching the warning sleeve.

FIG. 6 is a side view of a filtered smoking article incorporating a second embodiment of a warning sleeve according to this invention.

FIG. 7 is a side view of a filtered smoking article incorporating a third embodiment of a warning sleeve according to this invention.

FIG. 8 is a side view of an unfiltered smoking article having thereon a slidable sleeve according to this invention.

FIG. 9 is a side view of a smoking article incorporating a further embodiment of this invention.

FIG. 10 is a side view of a smoking article incorporating a further embodiment of this invention.

FIG. 11 depicts a mode of the device herein having one or a plurality of biased members acting to extinguish the smoking article such as a cigarette.

FIG. 12 depicts the device of FIG. 11 initiating closure once the ember on the smoking article passes a position wherein supports for the biased members are removed.

FIG. 13 depicts a mode of the device formed of metal or ceramic which acts as a heat sink to absorb sufficient heat from the ember to extinguish it.

### DESCRIPTION OF THE PREFERRED EMBODIMENT

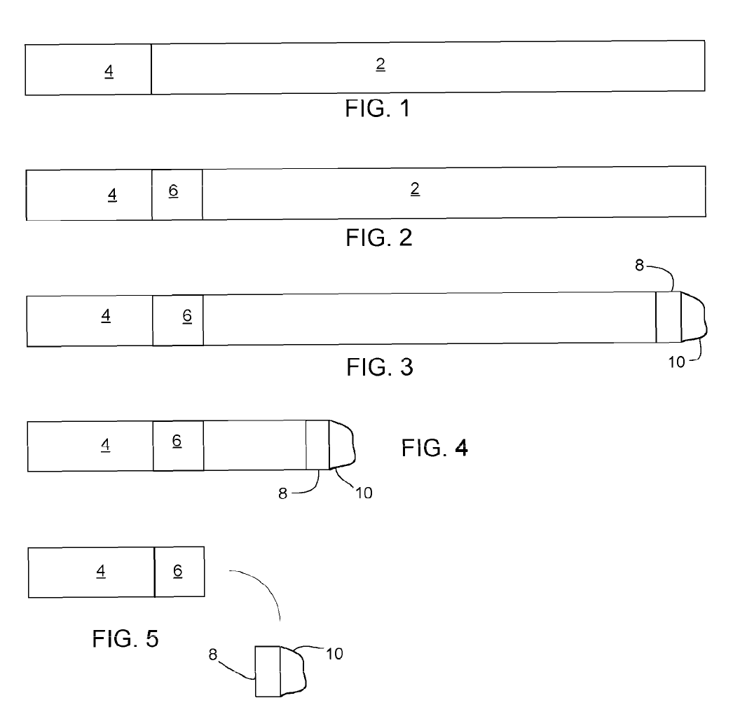

Referring to FIGS. 1-5, a typical filtered smoking article is shown in FIG. 1 to include a cylinder of tobacco 2 that is wrapped in smoking paper. The tobacco cylinder is followed immediately by a filter 4. FIG. 2 illustrates a smoking article, such as in FIG. 1, that includes a warning sleeve 6 according to this invention. The sleeve 6 is substantially disposed around the tobacco cylinder 2 immediately preceding the filter 4. This positioning point for the sleeve 6, may be pre-selected by a user or smoker for the purpose of alerting the smoker when the ember has reached the tobacco-filter interface.

The device as shown in the as-used position of FIGS. 3 and 4 illustrates the smoking article of FIG. 2 having been lit and burning with an ember 8 leaving an ash 10. In operation, with the sleeve 6 in the as-used position, when the ember 8 reaches the sleeve 6, the sleeve 6 provides a visual, auditory or olfactory means for warning in that it changes color due to the heat, or sparkles or sizzles due to burning, or any one or combination of this group of indications.

According to this invention, in all modes of the sleeve device disclosed, the warning sleeve 6 may be made from or impregnated with or coated with a non-toxic material 11 that will distinctively change color when heated significantly above ambient temperatures. An example of such material are polymers recently developed by chemists B. Lucht, R. Euler, and O. Gregory at the University of Rhode Island that change color when heated. One such polymer changes from red to yellow at 180″ Fahrenheit—the temperature at which a person would suffer a burn. These polymers can be added to a variety of products, even to paints and ink. Also preferably, a sleeve according to this invention is noncombustible relative to the other components of a conventional smoking article.

Alternately or in combination, a visual means for warning may be provided where the sleeve 6 can be made from or impregnated or coated with non-toxic material the sparkles or sizzles when it is in contact with an ember 8. An example of such material are the chemical mixtures used to make conventional sparklers, which typically consist of an oxidizer such as nitrates, perchlorates or chlorates; a metal powder for example iron or aluminum; a reducing agent for example charcoal; and a combustible binder for example dextrin. Also alternatively, the sleeve 6 may be incorporated into a filter.

Alternately, the sleeve 6 or an ember-reactive material can comprise such non-toxic color-changing, sparkling and/or sizzling compounds or mixtures integral with a wrapper of a smoking article. For example, they can be painted on or impregnated into a small band around the tobacco cylinder or on spots on the cylinder's paper wrapper spaced around the tobacco cylinder so as to be visible no matter which way the cylinder is rotated.

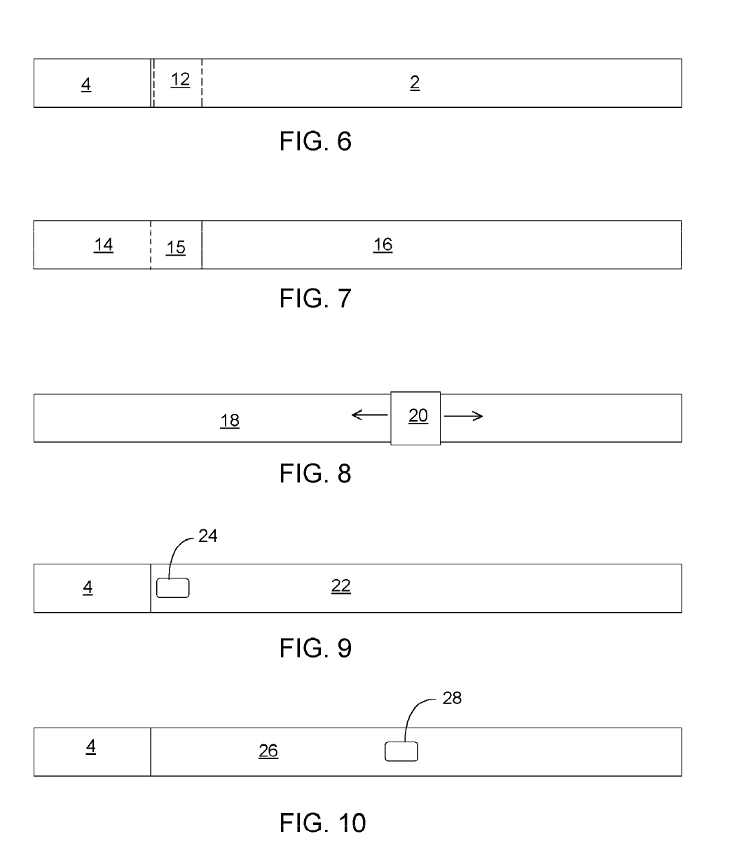

Referring to FIG. 6, alternately a smoking article can be manufactured with an internal warning sleeve 12. As illustrated, the warning sleeve 12 is positioned around the tobacco cylinder but inside the paper wrapper 16.

Referring to FIG. 7, alternately a smoking article can be manufactured with a warning sleeve 15 being a hollow extension of the filter, in which case the color-changing, sparkling and/or sizzling compounds or mixtures are preferably painted on or impregnated into the filter extension. As illustrated, the filter 14 includes the integral hollow sleeve 14 immediately following the tobacco paper wrapper 16.

Referring to FIG. 8, a slidable warning sleeve 20 provides another mode of the device according to this invention and is shown to be disposed around the tobacco cylinder 18 of a smoking article such as a cigarette. The warning sleeve 20 can be selectively moved up and down the length of the cylinder by the user, as indicated by the arrows. The translateable warning sleeve 20 is preferably held in any user-selected position by frictional engagement upon the paper wrapper 16. This allows the user to slide the warning sleeve 20 to a position wherein the ember contacting it will act on material 11 upon the warning sleeve 20 to initiate the visual, auditory or olfactory warning and/or extinguish the ember 8 if the warning sleeve 20 is formed of ceramic, or metal, or a material adapted to absorb sufficient heat from the ember 8 to cease combustion of the smoking article. Fins might be added to the warning sleeve 20 to allow it dissipate heat to the surrounding air. Further, the warning sleeve 20 as noted, may be coated with a material which provides an olfactory warning to the user that the ember 8 is in contact or proximate to the warning sleeve 20. There are many types of olfactory agents which may be included in the material and ignite to alert a user upon a proximity to the ember 8. The odor may be pungent such as that of a skunk, or may be pleasant such as pachouli oil. Of course those skilled in the art will realize that the material on the warning sleeve 20 may be applied to yield virtually any odor and all odorous agents which may be included in material on the warning sleeve 20 or other modes of the sleeve 6 as would occur to those skilled in the art are anticipated within the scope of this patent.

Referring to FIG. 9, it depicts a mode of the sleeve 6 device having a warning patch 24 according to this invention instead of a sleeve 6 as illustrated in the various modes of the sleeve 6 in other drawings. The patch 24 may be impregnated in or deposited on the paper wrapper or skin of the tobacco cylinder 22 proximate a filter 4 of a smoking article. The patch 24 may also have a sticky backing (not shown) so that a smoker can selectively stick it anywhere along the smoking article. In FIG. 9 the patch is in a position to warn a smoker if the ember is very near the filter 4. The patch 24 can be impregnated with material 11 to provide an olfactory warning, or visual warning, or both which as noted provides the user an alert even in a darkened room.

Referring to FIG. 10, a warning patch 28 according to this invention is illustrated to be disposed midway along the tobacco cylinder 26 of a smoking article. This disposition provides a warning to a smoker when the smoking article is halfway consumed.

This warning patch may be impregnated in or deposited on the paper wrapper, or may be stick-on patch. The material included in the patch 28 may provide the visual and or olfactory warning to the user. A halfway warning can be advantageous when a smoker who is trying to quit wants to smoke only half a cigarette at a time, or when a person of limited financial resources is trying to conserve his or her smokes.

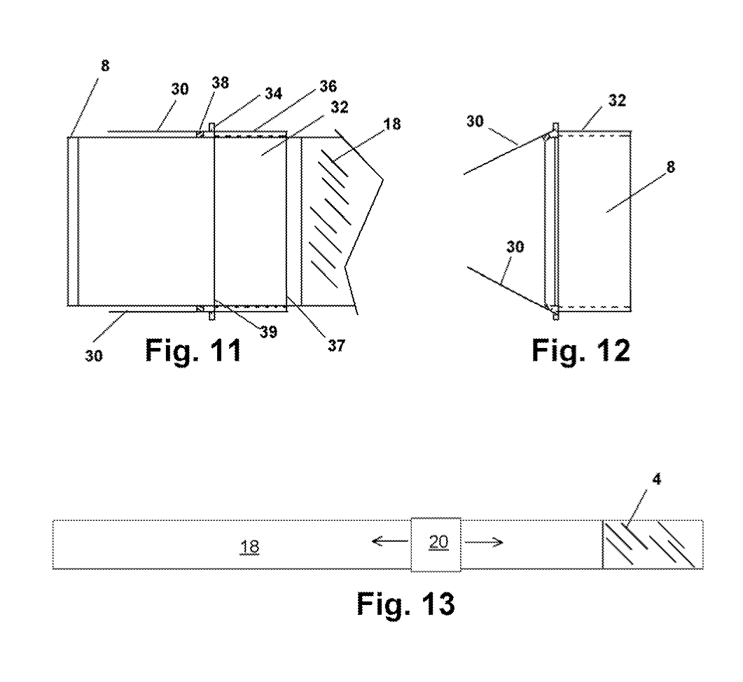

In FIG. 11 there is shown, a mode of the device herein having one or a plurality of biased members 30 engaged to the sleeve 32 and biased inward by a biasing means such as a hinged spring 34, or other means to bias the members 30 toward the center axis of the sleeve 32 which also runs through the smoking article. The members 30 so biased will act provide a means to extinguish the smoking article such as a cigarette by covering the aperture communicating with the axial cavity and depriving the ember of oxygen in stead of absorbing sufficient heat as in other modes of extinguishment herein. An interior wall 36 forms an axial cavity 37 adapted to frictionally engage upon the smoking article, yet allow a sliding thereof for a pre-positioning to any position along the burning path between the distal end having the ember 8 and ash 10, or the proximal end having the filter 4.

The sleeve 32 in this fashion, or other modes of the basic sleeve 6, may be formed of metal, or ceramic material which will allow for reuse on a plurality of smoking articles.

Additionally, employing metal or ceramic material for the sleeve 32 or other modes of the basic sleeve 6 in any mode of the device herein, also provides a means to passively extinguish the ember 8 by acting as a heat sink and oxygen blocker which combines to suffocate the flame and leach sufficient heat to cause an extinguishment of the ember 8. As noted above the material, may be coated to, or form, or otherwise be positioned on the sleeve 32 an any of the aforementioned manners.

FIG. 12 depicts the device of FIG. 11 wherein the sleeve 32 is in an as-used position and the members 30 are biased closed or toward the center axis of the sleeve 32 interior cavity depicted in FIG. 11. A shoulder 38 may be positioned on the members 30 to communicate a support from the surface of the smoking article and thereby maintain them out of contact with the exterior of the smoking article, for instance the combustible paper sidewall on the exterior of a cigarette. The shoulder 38 acts to hold the members 30 substantially parallel to the sidewall and axis of the smoking article but out of a contact with it. This positioning allows the ember 8 to burn toward the aperture defined by the leading edge 39 of the sleeve 32. Once the ember 8 burns to a position adjacent to the leading edge 39, it burns the paper and underlying tobacco which both provide support for the shoulder 38 to resist the bias inward. Removal of this communicated support allows the biased member or members 30 to close over the aperture in front edge of the sleeve 32 and extinguish the ember by absorbing heat and/or preventing oxygen from reaching the ember 8.

FIG. 13 depicts a mode of the device herein having the sleeve 32 formed of metal or ceramic material or other non combustible material which absorb heat as would occur to those skilled in the art. As noted any of the modes of the sleeve 6 herein may employ such material which is preferred since it acts as a heat sink to absorb sufficient heat from the ember 8 to extinguish it, or remains upon the smoker article and starves sufficient oxygen from the ember 8 burning past the leading edge 39 thereby having the same effect. The sleeve 32 so formed is rendered translatable to a user-chosen position as it has an interior wall sized to provide a frictional engagement upon the circumference of the smoking article such as a cigarette.

It should be noted that the figures and the descriptions referencing the figures focuses primarily on a filtered smoking article but, as previously explained, this invention is equally applicable to any smoking article whether filtered or unfiltered.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims. For example, the above specification addresses warning material only in the form of a sleeve, but this invention and the appended claims also encompass warning material in other forms. For another example, the warning material can be in the form of one or more individual spots of material strategically placed in the tobacco burning path of a smoking article's ember at a pre-selected point, such as ember-reactive material integral with a wrapper of a smoking article—the material is painted-on or impregnated in the wrapper.

Further, while all of the fundamental characteristics and features of the safety device for smoking articles been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An apparatus providing an alert to a smoker of a smoking article when an ember burning from a distal end toward a proximal end of said smoking article reaches a preselected point on the article, comprising:
a sleeve a having an interior wall defining an axial cavity communicating between a leading edge and second edge;
said interior wall dimensioning said axial cavity to a frictional engagement upon an exterior circumference of said smoking article;
said frictional engagement providing means for translational positioning of said sleeve to a user-selected intercepting point between said distal end and said proximal end;
material engaged with said sleeve, said material producing a human detectable alert in response to a close proximity of the ember, said human detectable alert providing means for alerting the smoker that the ember has reached the intercepting point.

2. The device according to claim 1 wherein said sleeve is formed of non combustible material whereby said sleeve is employable on multiple smoking articles.

3. The device according to claim 1 wherein said material provides one or a combination of said alerts from a group of alerts including an audible noise, a visually perceivable change in appearance, and a smell.

4. The device according to claim 2 wherein said material provides one or a combination of said alerts from a group of alerts including an audible noise, a visually perceivable change in appearance, and a smell.

5. The device according to claim 3 wherein said visually perceivable change is provided by material which sparkles in reaction to a proximity to said ember.

6. The device according to claim 4 wherein said visually perceivable change is provided by material which sparkles in reaction to a proximity to said ember.

7. The device according to claim 3 wherein said audible noise is provided by said material which audibly sizzles in reaction to the ember.

8. The device according to claim 4 wherein said audible noise is provided by said material which audibly sizzles in reaction to the ember.

9. An apparatus providing an alert to a smoker of a filtered cigarette when a cigarette ember of burning tobacco is in an unsafe proximity to said filter comprising:
material disposed along a burning path of an ember of said tobacco;
said burning path of said ember being toward said filter from a starting point at a distal end of said cigarette opposite said filter;
said material producing an indication in a response to a communication with said ember;
said indication providing means for alerting the smoker that the ember is in close proximity to the filter.

10. The device according to claim 9 wherein the material visibly changes color in reaction to the said communication with said ember.

11. The device according to claim 9 wherein the material sparkles in reaction to said communication with said ember.

12. The device according to claim 9 wherein said material audibly sizzles in a reaction to said communication with said ember.

13. The device according to claim 9 wherein the material is integral with said filter.

14. The device according to claim 9 wherein the material is disposed within an outer wrapping of the smoking article.

15. The device according to claim 13 wherein the material is integral with the wrapper.

16. An apparatus providing an alert to a smoker of a smoking article having a path of a burning ember progressing from a distal end, toward an engagement point with a body part of said smoker which is at or adjacent to a proximal end of said smoking article, comprising:
a sleeve disposed about the article at a pre-selected point along said path;
said smoking article extending through an axial cavity through a first aperture and having said distal end extending through a second aperture;
a closure rotationally engaged at said distal end;
said closure having a first position said first position substantially parallel to an axis running through both said smoking article and said axial cavity;
said closure having a second position, substantially covering said second aperture;
means to bias said closure toward said second position;
a communication between said exterior surface of said smoking article and said closure providing a support, said support forming a means to maintain said closure in said first position;
a positioning of said ember in or adjacent to said second aperture combusting said exterior surface resulting in a removal of said support; and
said removal of said support causing a rotation of said closure to said second position whereby an extinguishment of said ember results.

17. The device according to claim 16 additionally comprising:
said sleeve having a sliding engagement with said smoking article; and
said sliding engagement providing means for said user to adjust a position of said pre-selected point along said path.

18. The device according to claim 16 additionally comprising:
said sleeve having a material in combination therewith, said material producing an indication perceivable by a smoker of said smoking article that said ember is proximate to said pre-selected point.

19. The device according to claim 18 additionally comprising:
said indication includes one or a combination of indications from a group including, a visible color change of said material, a sparkling of said material, an audible sizzle of said material.

20. The device according to claim 17 additionally comprising:
said sleeve formed of metal, said metal forming a heat sink for heat radiating from said ember; and
said heat sink providing a secondary extinguishment of said ember.
